(19) United States
(12) Patent Application Publication
(10) Pub. No.: US 2026/0145919 A1
(43) Pub. Date: May 28, 2026

(54) PRESSURE COMPENSATION VALVE AND HYDRAULIC CONTROL SYSTEM

(71) Applicant: Zhejiang Senstren Technology Co., LTD, Zhuji City (CN)

(72) Inventors: Feng PENG, Zhuji City (CN); Yulin MO, Zhuji City (CN); Kepeng ZHANG, Zhuji City (CN)

(21) Appl. No.: 19/378,982

(22) Filed: Nov. 4, 2025

(30) Foreign Application Priority Data
Nov. 22, 2024 (CN) 202411683785.7
Nov. 22, 2024 (CN) 202422860672.1
Nov. 22, 2024 (CN) 202422861436.1

(51) Int. Cl. B66F 3/25; F15B 13/02

(52) U.S. Cl. CPC B66F 3/25; F15B 13/026; F15B 2211/50572

(57) ABSTRACT

A pressure compensation valve includes a valve sleeve, a valve seat, and a valve core. An oil inlet hole, an oil return hole, and an oil feedback hole are disposed on the valve sleeve. The inner wall of the valve sleeve is provided with a connecting corner. The valve core is slidably disposed inside the valve sleeve in the axial direction of the valve core to block or open the oil return hole. The valve core has a first valve core segment and a second valve core segment. The first valve core segment and the valve seat enclose to form a first cavity. An oil passing gap is disposed between the first valve core segment and the valve seat. The oil passing gap communicates with the first cavity and the oil feedback hole. A sealing portion is disposed between the first valve core segment and the second valve core segment.

### CROSS-REFERENCE TO RELATED APPLICATION(S)

This application claims priority to Chinese Patent Applications No. 202422861436.1, No. 202411683785.7, and No. 202422860672.1 filed Nov. 22, 2024, the disclosure of which is incorporated herein by reference in its entirety.

### TECHNICAL FIELD

The present application relates to the technical field of hydraulic valves and, in particular, to a pressure compensation valve and a hydraulic control system.

### BACKGROUND

Pressure compensation valves are widely used in the field of construction machinery. Taking a forklift as an example, after the forklift lifts a cargo to a preset position, a pressure holding requirement is needed. That is, the cargo does not lower due to the gravity of the cargo. However, the pressure compensation valves in the industry generally have the problem of hydraulic oil leakage, resulting in a poor hydraulic control effect.

Therefore, a pressure compensation valve and a hydraulic control system are needed to solve the preceding technical problem.

### SUMMARY

The present application provides a pressure compensation valve to solve the problems of a poor sealing effect between a valve core and a valve sleeve, high difficulty in processing a sealing structure, and high costs.

The pressure compensation valve includes a valve sleeve, a valve seat, and a valve core.

An oil inlet hole, an oil return hole, and an oil feedback hole are disposed on the valve sleeve. An inner wall of the valve sleeve is provided with a connecting corner. The connecting corner is located between the oil return hole and the oil feedback hole.

The valve seat is connected to the valve sleeve.

The valve core is slidably disposed inside the valve sleeve in an axial direction of the valve core to block or open the oil return hole. The valve core has a first valve core segment and a second valve core segment. The first valve core segment and the valve seat enclose to form a first cavity. An oil passing gap is disposed between the first valve core segment and the valve seat. The oil passing gap communicates with the first cavity and the oil feedback hole. A sealing portion is disposed between the first valve core segment and the second valve core segment. The sealing portion is configured to abut against the connecting corner to block a gap between the valve core and part of the valve sleeve between the oil return hole and the oil feedback hole.

The pressure compensation valve further includes a hydraulic control system so that the load is held at a certain height without shaking, thus improving the hydraulic control effect.

The hydraulic control system includes a lifting oil cylinder and a lifting module configured to control the lifting oil cylinder to perform a lifting action. The lifting module includes an oil inlet and an oil outlet. A solenoid valve is disposed between the oil inlet and an oil inlet end of the lifting oil cylinder.

A proportional flow valve and the pressure compensation valve according to claims are sequentially disposed between the oil inlet end of the lifting oil cylinder and the oil outlet. The oil inlet hole of the pressure compensation valve communicates with the proportional flow valve. The oil return hole communicates with the oil outlet. The oil feedback hole communicates with the oil inlet end of the lifting oil cylinder.

The present application discloses a pressure compensation valve and a hydraulic control system. The pressure compensation valve includes a valve sleeve, a valve seat, and a valve core. An oil inlet hole, an oil return hole, and an oil feedback hole are disposed on the valve sleeve. An inner wall of the valve sleeve is provided with a connecting corner. The connecting corner is located between the oil return hole and the oil feedback hole. The valve seat is connected to the valve sleeve. The valve core is slidably disposed inside the valve sleeve in an axial direction of the valve core to block or open the oil return hole. The valve core has a first valve core segment and a second valve core segment. The first valve core segment and the valve seat enclose to form a first cavity. An oil passing gap is disposed between the first valve core segment and the valve seat. The oil passing gap communicates with the first cavity and the oil feedback hole. A sealing portion is disposed between the first valve core segment and the second valve core segment. The sealing portion is configured to abut against the connecting corner to block a gap between the valve core and part of the valve sleeve between the oil return hole and the oil feedback hole.

In the pressure compensation valve, when hydraulic oil enters from the oil feedback hole, the hydraulic oil may push the valve core to move from left to right. When the valve core moves to make the sealing portion abut against the connecting corner, the sealing portion and the connecting corner can form conical sealing, thus performing effective sealing on a gap formed between the valve core and the valve sleeve between the oil return hole and the oil feedback hole, thus effectively avoiding the leakage of the hydraulic oil, thereby generating a good sealing effect, resulting in low processing difficulty and low processing costs, and facilitating production and use.

The present application further discloses a hydraulic control system. The hydraulic control system includes a lifting oil cylinder and a lifting module controlling the lifting oil cylinder to perform a lifting action. The lifting module includes an oil inlet and an oil outlet. A solenoid valve is disposed between the oil inlet and an oil inlet end of the lifting oil cylinder. A proportional flow valve and the pressure compensation valve according to claims are sequentially disposed between the oil inlet end of the lifting oil cylinder and the oil outlet.

In this hydraulic control system, the pressure compensation valve has a sealing portion which can strictly form conical sealing with a connecting corner, thus avoiding the leakage of the hydraulic oil, thereby enabling the hydraulic system to have good stability when the load is held, and thus improving the control effect of the hydraulic system.

### BRIEF DESCRIPTION OF DRAWINGS

FIG. 1 is a sectional view illustrating the sealing state of a pressure compensation valve according to an embodiment of the present application.

FIG. 2 is a sectional view illustrating the operating state of the pressure compensation valve according to an embodiment of the present application.

FIG. 3 is a view illustrating that a hydraulic control system lifts a cargo according to an embodiment of the present application.

FIG. 4 is a view illustrating that the hydraulic control system holds the load according to an embodiment of the present application.

FIG. 5 is a sectional view of a pressure compensation valve according to an embodiment of the present application.

FIG. 6 is a sectional view of a pressure compensation valve according to an embodiment of the present application.

### REFERENCE LIST

10 valve sleeve
11 oil inlet hole
12 oil return hole
13 oil feedback hole
14 connecting corner
15 first main body
16 second main body
20 valve seat
30 valve core
31 first valve core segment
311 oil passing groove
32 second valve core segment
33 sealing portion
34 receiving cavity
41 first cavity
42 oil passing gap
43 second cavity
51 throttle hole
52 accommodation cavity
53 oil passage
531 first oil passing hole
532 second oil passing hole
533 annular groove
60 blocking member
70 plug
80 elastic structure
81 elastic member
82 mounting member
100 lifting oil cylinder
200 solenoid valve
300 proportional flow valve
400 filter screen

### DETAILED DESCRIPTION

The present application is further described in detail hereinafter in conjunction with drawings and embodiments. It is to be understood that the examples described herein are merely intended to illustrate the present application. Additionally, it is to be noted that for ease of description, only part, not all, of structures related to the present application are illustrated in the drawings.

In the description of the present application, terms “joined”, “connected”, and “secured” are to be understood in a broad sense unless otherwise expressly specified and limited. For example, the term “connected” may refer to “securely connected”, “detachably connected”, or “integrated”, may refer to “mechanically connected” or “electrically connected”, may refer to “connected directly” or “connected indirectly through an intermediary”, or may refer to “connected inside two components” or “an interaction relation between two components”. For those of ordinary skill in the art, specific meanings of the preceding terms in the present application may be understood based on specific situations.

In the present application, unless otherwise expressly specified and limited, when a first feature is described as “on” or “below” a second feature, the first feature and the second feature may be in direct contact or be in contact via another feature between the two features instead of being in direct contact. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

In the description of this embodiment, orientations or position relations indicated by terms such as “above”, “below”, and “right” are based on the drawings. These orientations or position relations are intended to facilitate description and simplify operations and not to indicate or imply that an apparatus or element referred to must have such particular orientations or must be configured or operated in such particular orientations. Additionally, terms “first” and “second” are used only for the distinguishing purpose and have no special meanings.

When a forklift lifts a cargo, a proportional valve and a pressure compensation valve are usually disposed in series to perform pressure compensation for the proportional valve. In this case, the pressure difference between the front end of the proportional valve and the rear end of the proportional valve does not vary with the load weight. However, when the load is held at a preset height, hydraulic oil may leak from a gap between a valve core and a valve sleeve. The adoption of the method of reducing the matching gap between the valve core and the valve sleeve to guarantee sealing increases processing difficulty and greatly raises manufacturing costs.

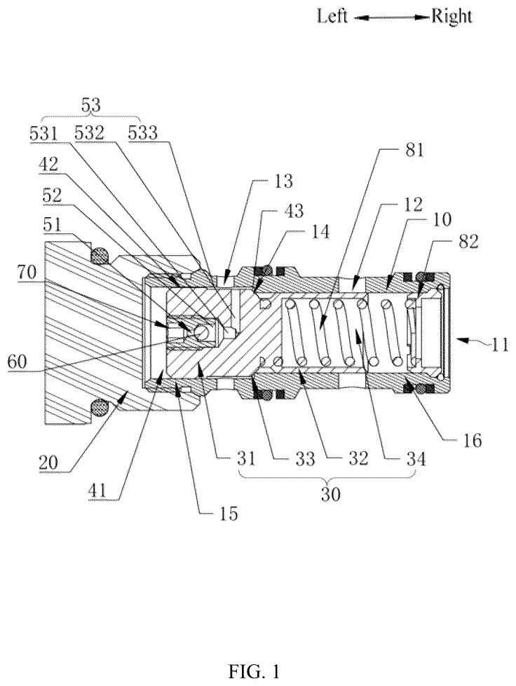

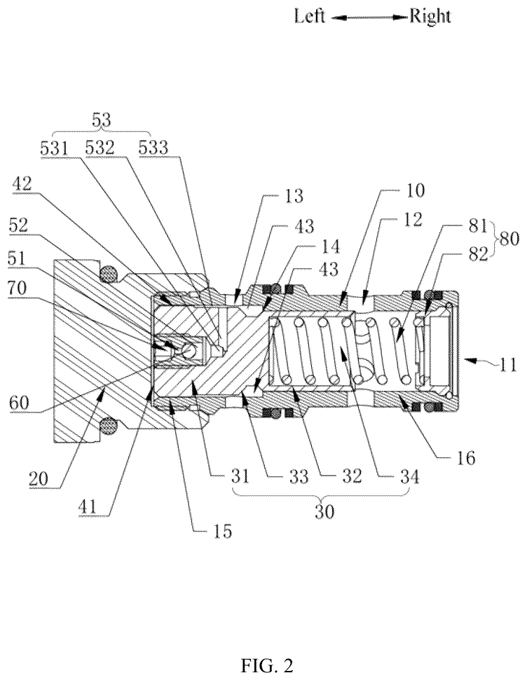

As shown in FIGS. 1 and 2, this embodiment provides a pressure compensation valve. The pressure compensation valve is disposed on the rear end of a proportional valve. The pressure compensation valve includes a valve sleeve 10, a valve seat 20, a valve core 30, and an elastic structure 80. An oil inlet hole 11, an oil return hole 12, and an oil feedback hole 13 are disposed on the valve sleeve 10. The inner wall of the valve sleeve 10 is provided with a connecting corner 14. The connecting corner 14 is located between the oil return hole 12 and the oil feedback hole 13. The valve seat 20 is connected to the valve sleeve 10. The valve core 30 is slidably disposed inside the valve sleeve 10 in the axial direction of the valve core 30 to block or open the oil return hole 12. The valve core 30 has a first valve core segment 31 and a second valve core segment 32. The first valve core segment 31 and the valve seat 20 enclose to form a first cavity 41. An oil passing gap 42 is disposed between the first valve core segment 31 and the valve seat 20. The oil passing gap 42 communicates with the first cavity 41 and the oil feedback hole 13. A sealing portion 33 is disposed between the first valve core segment 31 and the second valve core segment 32. The sealing portion 33 is configured to abut against the connecting corner 14 to block a gap between the valve core 30 and part of the valve sleeve 10 between the oil return hole 12 and the oil feedback hole 13. The elastic structure 80 is disposed between the valve sleeve 10 and the second valve core segment 32.

The valve core 30 of the pressure compensation valve is provided with the sealing portion 33. When hydraulic oil enters from the oil feedback hole 13 and pushes the valve core 30 to move from left to right, the sealing portion 33 abuts against the connecting corner 14, thereby preventing the hydraulic oil flowing from the oil feedback hole 13 from flowing out through the oil return hole 12, generating a good sealing effect, and avoiding the leakage of the hydraulic oil when the load is held.

Taking a forklift as an example, when the fork of the forklift is lifted or lowered, the hydraulic oil usually sequentially passes through a one-way valve, a solenoid valve, or a proportional valve to reach a lifting oil cylinder and pushes the cylinder up to lift a cargo. When the cargo is held, the self-weight of the cargo acts on the oil cylinder and generates hydraulic pressure to the oil cavity of the oil cylinder. The hydraulic oil in the oil cavity is stopped by the one-way valve, the proportional valve and the pressure compensation valve, thereby guaranteeing that the cargo is stable in a rising position. When the cargo needs to be lowered, the solenoid valve is energized. The hydraulic oil returns to the oil tank to complete the lowering action. The proportional valve controls the current to control the lowering speed. The pressure compensation valve can keep the pressure difference at the opening of the proportional valve basically constant so that the lowering speed is not affected by the load. However, the pressure compensation valve is usually a spool valve structure, undoubtedly resulting in the problem that the hydraulic oil leaks from the oil return hole 12. In this embodiment, the sealing portion 33 abuts against the connecting corner 14, guaranteeing a good sealing effect. Moreover, there is no need to adopt the method of reducing the matching gap between the valve core 30 and the valve sleeve 10 to solve the sealing problem, thereby reducing the overall processing difficulty.

Additionally, as shown in FIGS. 1 and 2, the valve sleeve 10 includes a first main body 15 and a second main body 16 connected to each other in the axial direction of the valve sleeve 10. The inner diameter of the first main body 15 is greater than the inner diameter of the second main body 16. The connecting corner 14 is formed at the connection between the first main body 15 and the second main body 16. That is, the connecting corner 14 is a step structure formed by connecting the first main body 15 to the second main body 16. This structure can simplify the internal structure of the valve sleeve 10. The connecting corner 14 can be formed by integrally molding the first main body 15 and the second main body 16 with different diameters without an additional separate arrangement in the valve sleeve 10, thereby reducing overall manufacturing and use costs.

Additionally, as shown in FIGS. 1 and 2, the diameter of the first valve core segment 31 is greater than the diameter of the second valve core segment 32. The first valve core segment 31 is connected to the second valve core segment 32 through a conical segment. The outer diameter of an end of the conical segment connected to the first valve core segment 31 is greater than the outer diameter of an end of the conical segment connected to the second valve core segment 32. The circumferential surface of the conical segment forms the sealing portion 33. The valve core 30 is coaxial with the valve sleeve 10. The first valve core segment 31 is located (slidably disposed) inside the first main body 15. The second valve core segment 32 is slidably guided within the second main body 16.

The arrangement in which the first valve core segment 31 is connected to the second valve core segment 32 through the conical segment can not only simplify the overall structure but also form the flat sealing portion 33, thereby improving the abutting and sealing effect between the sealing portion 33 and the connecting corner 14. It is to be noted that in this embodiment, the sealing portion 33 is a sealing inclined surface that can abut against the connecting corner 14 to form conical sealing. With the arrangement in which the second valve core segment 32 is slidably guided within the second main body 16, the second valve core segment 32 can only slide in the axial direction of the valve sleeve 10, thereby reducing the collision or wear between the valve core 30 and the valve sleeve 10, prolonging the service life of the pressure compensation valve, and guaranteeing a good use effect. It is to be noted that the diameter of the second valve core segment 32 of the valve core 30 may be slightly smaller than the inner diameter of the second main body 16. That is, the difference between the inner diameter of the valve sleeve 10 and the diameter of the second valve core segment 32 of the valve core 30 is kept within a tolerance allowable range of 0.01 mm to 0.02 mm.

As shown in FIGS. 1 and 2, the oil passing gap 42 is disposed as an annular cavity between the valve core 30 and the valve seat 20 in the axial direction of the valve core 30. The size of the oil passing gap 42 between the valve core 30 and the valve seat 20 on one side of the valve core 30 is 0.2 mm to 0.5 mm. That is, the diameter of the first valve core segment 31 is 0.4 mm to 1 mm smaller than the inner diameter of the first main body 15 (0.2 mm to 0.5 mm on one side of the valve core 30). Accordingly, the oil passing gap 42 is naturally formed in between, thereby simplifying the overall structure and guaranteeing that the hydraulic oil can smoothly flow into the first cavity 41 through the oil passing gap 42 or flow out through the oil passing gap 42.

Additionally, in other embodiments, the pressure compensation valve further includes an oil passing groove 311 located in the valve seat 20 and/or the valve core 30. In a case where the oil passing groove 311 is located in the valve seat 20, the groove wall of the oil passing groove 311 is recessed relative to the inner wall of the valve seat 20 towards a side away from the valve core 30 to form the oil passing gap 42. In a case where the oil passing groove 311 is located in the valve core 30, the wall of the oil passing groove 311 is recessed relative to the surface of the valve core 30 towards a side away from the valve seat 20 to form the oil passing gap 42. The oil passing gap 42 formed through this structure may be a groove extending in the axial direction of the valve core 30 or an annular gap. Either structure can guarantee that the hydraulic oil flows in the oil passing gap 42. Moreover, a structure in which the oil passing groove 311 is disposed only in the valve seat 20 may be selected according to actual needs; alternatively, a structure in which the oil passing groove 311 is disposed only in the valve core 30 may be selected; alternatively, a structure in which the oil passing groove 311 is disposed in both the valve seat 20 and the valve core 30 may be selected.

Additionally, as shown in FIGS. 1 and 2, the first valve core segment 31 is provided with a one-way throttle channel communicating with the first cavity 41 and the oil feedback hole 13. A blocking member 60 is disposed inside the one-way throttle channel. The blocking member 60 is configured to control the one-way flow of the hydraulic oil from the first cavity 41 to the one-way throttle channel. This structure can adjust the opening degree of the oil return hole 12 according to a change in the system pressure, thereby keeping the pressure difference between the front end of the proportional valve and the rear end of the proportional valve constant and guaranteeing a smooth operation even when the load changes.

In this embodiment, as shown in FIGS. 1 and 2, the diameter of the first valve core segment 31 is greater than the diameter of the second valve core segment 32. Moreover, the outer periphery of the first valve core segment 31 and the inner wall of the first main body 15 of the valve sleeve 10 form a second cavity 43. The second cavity 43 communicates with the oil passing gap 42 through an annular groove 533 (the second cavity 43 is located on the right side of the oil passing gap 42). The valve seat 20 is disposed on the left end of the valve sleeve 10. The oil inlet hole 11 is disposed on the right end of the valve sleeve 10. The oil return hole 12 and the oil feedback hole 13 are each disposed in the circumferential direction of the valve sleeve 10. The oil feedback hole 13 is located on the left side of the oil return hole 12. The movement of the valve core 30 in the axial direction of the valve core 30 can change the area blocking the oil return hole 12 so as to change the opening degree of the oil return hole 12. After passing through the oil feedback hole 13, the hydraulic oil may enter the second cavity 43 first, then enter the first cavity 41 through the oil passing gap 42 and act on the left end of the valve core 30. It is assumed that the pressure at the front end of the proportional valve and the pressure at the rear end of the proportional valve are F1 and F2 respectively. The hydraulic oil can flow into the pressure compensation valve through the oil feedback hole 13 and flow into the first cavity 41 through the oil passing gap 42. The oil feedback hole 13 of the pressure compensation valve is connected to the front end of a flow meter. In this case, the pressure generated by the hydraulic oil in the first cavity 41 to the first valve core segment 31 is F1. As the hydraulic oil flows into the valve sleeve 10 through the oil inlet hole 11, the hydraulic oil in the valve sleeve 10 may generate pressure F2 on the second valve core segment 32 of the valve core 30 at this time. The remaining hydraulic oil can flow out through the oil return hole 12. The elastic structure is disposed between the valve sleeve 10 and the second valve core segment 32. It is assumed that the elastic force generated by the elastic structure is F3. It may be understood that F1=F2+F3 when the pressure compensation valve is in a balanced state.

When the load at the front end of the fork increases, the lowering speed of the fork also tends to increase. In this case, F1 increases so that the flow of the hydraulic oil entering the first cavity 41 through the oil feedback hole 13 increases, thereby enabling the valve core 30 to move to the right to reduce the opening degree of the oil return hole 12, thereby decreasing the flow of the hydraulic oil passing through the oil return hole 12, and thus decreasing the lowering speed of the fork. That is, it guarantees that the fork can still be lowered at a stable speed.

When the load at the front end of the fork decreases, the lowering speed of the fork also tends to decrease. In this case, F1 decreases so that the flow of the hydraulic oil entering the first cavity 41 through the oil feedback hole 13 decreases, thereby enabling the valve core 30 to move to the left to increase the opening degree of the oil return hole 12, thereby increasing the flow of the hydraulic oil passing through the oil return hole 12, and thus increasing the lowering speed of the fork. That is, it guarantees that the fork can still be lowered at a stable speed. In this case, part of the hydraulic oil in the first cavity 41 flows out through the oil passing gap 42, and part of the hydraulic oil flows into the one-way throttle channel and punches the blocking member 60 open to flow out through the one-way throttle channel.

When the load increases, the arrangement in which the hydraulic oil flowing from the oil feedback hole 13 flows into the first cavity 41 through the oil passing gap 42 reduces the flow speed of the hydraulic oil flowing into the first cavity 41, thus decreasing the speed of the valve core 30 moving to the right and thereby slowing down a change in the flow current at the oil return hole 12.

Specifically, as shown in FIGS. 1 and 2, the one-way throttle channel includes a throttle hole 51, an accommodation cavity 52, and an oil passage 53 sequentially communicating with each other. The other end of the throttle hole 51 communicates with the first cavity 41. The other end of the oil passage 53 communicates with the oil feedback hole 13. The blocking member 60 is disposed inside the accommodation cavity 52. The blocking member 60 is configured to make the throttle hole 51 and the accommodation cavity 52 disconnect from each other or communicate with each other. When the hydraulic oil in the first cavity 41 flows out through the one-way throttle channel, the hydraulic oil enters the throttle hole 51 first and then pushes the blocking member 60 away from the connection between the throttle hole 51 and the accommodation cavity 52 so that the hydraulic oil enters the oil passage 53 through the accommodation cavity 52. Finally, the hydraulic oil is discharged from the oil feedback hole 13 through the oil passage 53. The arrangement of the throttle hole 51 can limit the flow speed of the hydraulic oil, thus generating a good throttle effect. The arrangement of the blocking member 60 guarantees that the hydraulic oil can flow only in one direction and cannot enter the throttle hole 51 from the oil passage 53.

It is to be noted that in this embodiment, the blocking member 60 is a steel ball. The steel ball is simple in structure, is easy to produce, and has the features of high hardness, good wear resistance and corrosion resistance. The steel ball is selected to block the one-way throttle channel, facilitating mounting and generating a good one-way flow effect.

Additionally, as shown in FIGS. 1 and 2, the oil passage 53 includes a first oil passing hole 531, a second oil passing hole 532, and an annular groove 533 sequentially communicating with each other. The first oil passing hole 531 is disposed in the axial direction of the valve core 30. The second oil passing hole 532 is disposed in the radial direction of the valve core 30. The annular groove 533 is disposed in the circumferential direction of the valve core 30. The other end of the first oil passing hole 531 communicates with the accommodation cavity 52. The annular groove 533 communicates with both the oil feedback hole 13 and the oil passing gap 42. With this arrangement, the first oil passing hole 531 disposed in the axial direction of the valve core 30, the second oil passing hole 532 disposed in the radial direction of the valve core 30, and the annular groove 533 disposed in the outer periphery can match each other, simplifying the overall structure, enabling the hydraulic oil to flow smoothly in the oil passage 53 without generating excessive pressure loss and flow resistance, and guaranteeing a good use effect.

Additionally, as shown in FIGS. 1 and 2, the pressure compensation valve further includes a plug 70. The plug 70 is disposed inside the first valve core segment 31 of the valve core 30. The throttle hole 51 and the accommodation cavity 52 are each disposed inside the plug 70. As an independent component, the plug 70 can be precisely processed separately, thus guaranteeing the dimensional precision of the throttle hole 51 and the accommodation cavity 52. Moreover, the blocking member 60 can be placed in the accommodation cavity 52 more conveniently. In the case of a problem such as a blockage in the throttle hole 51 and the accommodation cavity 52, only the plug 70 is to be replaced with no need for replacing the entire valve core 30, reducing processing costs and assembly difficulty and facilitating subsequent maintenance and replacement.

It is to be noted that in this embodiment, as shown in FIGS. 1 and 2, the valve core 30 is provided with an accommodation groove for accommodating the plug 70. The inner wall of the accommodation groove is provided with screw threads. The plug 70 can be in a threaded connection with the accommodation groove of the valve core 30. Through the threaded connection, the plug 70 can be stably fixed in the accommodation groove of the valve core 30 and does not easily loosen or fall off. The threaded connection also facilitates subsequent maintenance and replacement. In the case of a problem such as a blockage, the plug 70 can be easily removed, thereby facilitating the replacement or repair of a component and improving maintenance efficiency. It is to be further noted that in other embodiments, the plug 70 may be fixed by snapping or through a locking member.

Additionally, as shown in FIGS. 1 and 2, the elastic structure 80 further includes an elastic member 81 and a mounting member 82. The mounting member 82 is disposed in the valve sleeve 10. One end of the elastic member 81 abuts against the second valve core segment 32. The other end of the elastic member 81 is connected to or abuts against the mounting member 82. The elastic member 81 can guarantee that the valve core 30 can move to a required position under different pressures, thus changing the area of blocking the oil return hole 12. The mounting member 82 provides a stable support effect for the elastic member 81 and facilitates the mounting of the elastic member 81.

It is to be noted that in this embodiment, the elastic member 81 is a spring. The spring has a simple structure, low cost, and is easy to produce and manufacture, thereby facilitating a reduction in costs. Additionally, a through hole penetrates the mounting member 82 in the axial direction of the mounting member 82 so that the hydraulic oil entering from the oil inlet hole 11 can enter the valve sleeve 10 through the through hole, thereby guaranteeing the subsequent hydraulic effect.

Additionally, as shown in FIGS. 1 and 2, the second valve core segment 32 of the valve core 30 is provided with a receiving cavity 34. At least part of the elastic member 81 extends into the receiving cavity 34 and abuts against the bottom of the receiving cavity 34. The elastic member 81 is arranged by disposing the receiving cavity 34 inside the valve core 30, reducing the outer dimension of the entire pressure compensation valve and guaranteeing the compactness of the internal structure of the valve body.

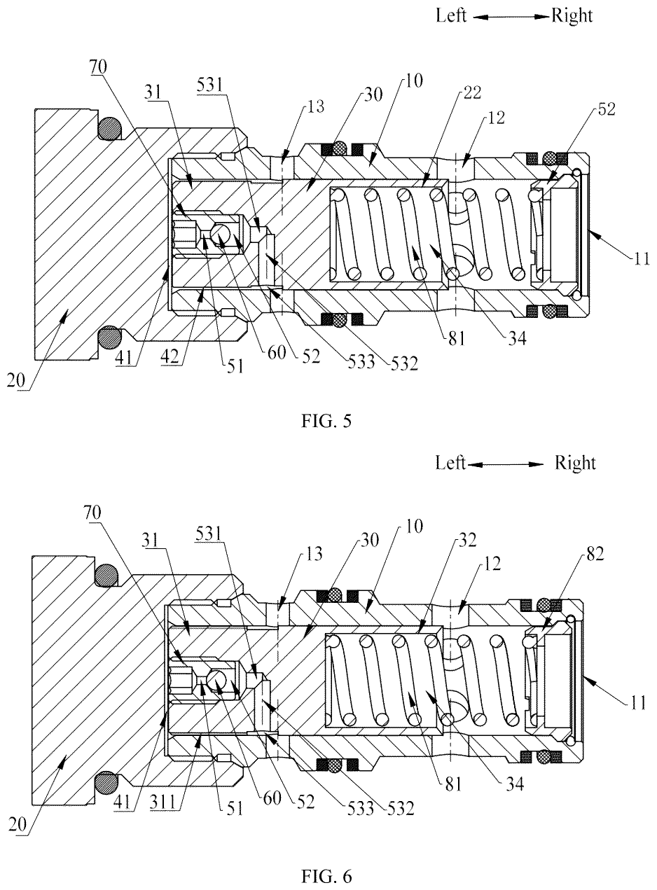

An embodiment, as shown in FIG. 5, further provides a pressure compensation valve. The pressure compensation valve is disposed on the rear end of a flow control valve. The pressure compensation valve includes a valve sleeve 10, a valve core 30, a valve seat 20, and an elastic structure 80. The valve sleeve 10 is internally hollow and includes a first main body 15 and a second main body 16 connected to each other in the axial direction. An oil inlet hole 11, an oil return hole 12, and an oil feedback hole 13 are disposed on the valve sleeve 10. The oil feedback hole 13 is connected to the front end of the flow control valve. The oil inlet hole 11 is connected to the rear end of the flow control valve. The valve seat 20 is disposed on one end of the valve sleeve 20. The valve core 30 is slidably disposed inside the valve sleeve 10 in the axial direction. The valve core 30 has a first valve core segment 31 and a second valve core segment 32. The diameter of the first valve core segment 31 is smaller than the diameter of the second valve core segment 32. The first valve core segment 31 is located inside the first main body 15. The second valve core segment 32 is slidably guided within the second main body 16. A first cavity 41 is formed between an end portion of the first valve core segment 31 and the valve seat 20. An oil passing gap 42 is located between the circumferential side of the first valve core segment 31 and the first main body 15 of the valve sleeve 10. The oil passing gap 42 exists between the circumferential side of the first valve core segment 31 and the first main body 15 of the valve sleeve 10. The oil passing gap 42 communicates with the first cavity 41 and the oil feedback hole 13. The first valve core segment 31 is provided with a one-way throttle channel communicating with the first cavity 41. A blocking member 60 is disposed inside the one-way throttle channel. The blocking member 60 is configured to control the one-way flow of the hydraulic oil from the first cavity 41 to the one-way throttle channel. The elastic structure 80 is elastically disposed between the valve sleeve 10 and the second valve core segment 32 of the valve core 30.

The pressure compensation valve can automatically adjust the opening degree of the oil return hole 12 according to a change in the system pressure, thereby keeping the pressure difference between the front end of the flow control valve and the rear end of the flow control valve constant and guaranteeing a smooth operation even when the load changes. That is, in this embodiment, it guarantees that the lowering speed of the fork is stable.

In this embodiment, as shown in FIG. 5, the valve seat 20 is disposed on the left end of the valve sleeve 10. The oil inlet hole 11 is disposed on the right end of the valve sleeve 10. The oil feedback hole 13 and the oil return hole 12 are sequentially disposed in the circumferential direction of the valve sleeve 10 from left to right. The sliding of the valve core 30 in the axial direction can change the area blocking the oil return hole 12 so as to adjust the opening degree of the oil return hole 12. It is assumed that the pressure at the front end of the flow control valve and the pressure at the rear end of the flow control valve are F1 and F2 respectively. The hydraulic oil can flow into the pressure compensation valve through the oil feedback hole 13 and flow into the first cavity 41 through the oil passing gap 42. The oil feedback hole 13 of the pressure compensation valve is connected to the front end of the flow control valve. In this case, the pressure generated by the hydraulic oil in the first cavity 41 to the first valve core segment 31 is F1. The hydraulic oil flows into the valve sleeve 10 through the oil inlet hole 11. In this case, the pressure generated by the hydraulic oil in the valve sleeve 41 to the second valve core segment 32 of the valve core 30 is F2, and part of the hydraulic oil can flow out through the oil return hole 12. The elastic structure 80 is elastically disposed between the valve sleeve 10 and the second valve core segment 32 of the valve core 30. Assuming that the elastic force of the elastic structure 80 is F3, it can be obtained that:

$$F 3 + F 2 = F 1. That is , F 3 = F 1 - F 2 .$$

When the load at the front end of the fork increases, the lowering speed of the fork also tends to increase. In this case, F1 increases so that the pressure of the hydraulic oil entering the first cavity 41 through the oil feedback hole 13 increases, thereby pushing the valve core 30 to move to the right to reduce the opening degree of the oil return hole 12, thereby decreasing the flow of the hydraulic oil at the oil return hole 12, finally decreasing the lowering speed of the fork, and guaranteeing that the fork can still be lowered at a stable speed.

When the load at the front end of the fork decreases, the lowering speed of the fork also tends to decrease. In this case, F1 decreases so that the pressure of the hydraulic oil entering the first cavity 41 through the oil feedback hole 13 decreases. The valve core 30 moves to the left under the action of the elastic structure 80 to increase the opening degree of the oil return hole 12, thereby increasing the flow of the hydraulic oil at the oil return hole 12, finally increasing the lowering speed of the fork, and guaranteeing that the fork can still be lowered at a stable speed. In this case, most of the hydraulic oil in the first cavity 41 flows into the one-way throttle channel and pushes the blocking member 60 to flow out from the one-way throttle channel; moreover, a small portion of the hydraulic oil flows out through the oil passing gap 42.

When the load increases, the hydraulic oil flowing from the oil feedback hole 13 needs to pass through the oil passing gap 42 to enter the first cavity 41. This process reduces the flow speed of the hydraulic oil flowing into the first cavity 41, thus decreasing the speed of the valve core 30 moving to the right, finally slowing down a change in the flow current at the oil return hole 12, and avoiding system chatter.

In this embodiment, as shown in FIG. 5, the one-way throttle channel includes a throttle hole 51, an accommodation cavity 52, and an oil passage 53 sequentially communicating with each other. The throttle hole 51 communicates with the first cavity 41. The oil passage 53 communicates with the oil feedback hole 13. The blocking member 60 is disposed inside the accommodation cavity 52. The blocking member 60 can block or open the throttle hole 51 to make the throttle hole 51 and the oil passage 53 disconnect from each other or communicate with each other. When the hydraulic oil in the first cavity 41 flows out through the one-way throttle channel, the hydraulic oil enters the throttle hole 51 first, then pushes the blocking member 60 open to flow out from the accommodation cavity 52, flows into the oil passage 53, and is finally discharged from the oil feedback hole 13. The throttle hole 51 can limit the flow speed of the hydraulic oil, thus generating a throttle effect. The blocking member 60 guarantees that the hydraulic oil can flow in one direction. That is, the hydraulic oil can flow only from the throttle hole 51 to the oil passage 53 and cannot flow in the opposite direction.

In this embodiment, the blocking member 60 is a steel ball. As a common mechanical component, the steel ball has the features of high hardness, good wear resistance, strong corrosion resistance, and long service life. Serving as the blocking member 60 in the one-way throttle channel, the steel ball can effectively control the opening and closing of the channel and implement the one-way flow of the hydraulic oil.

As shown in FIG. 5, a first oil passing hole 531 is disposed on the valve core 30 in the axial direction of the valve core 30. A second oil passing hole 532 is disposed on the valve core 30 in the radial direction of the valve core 30. An annular groove 533 is disposed on the valve core 30 in the circumferential direction of the valve core 30. The first oil passing hole 531, the second oil passing hole 532, and the annular groove 533 sequentially communicate with each other to form the oil passage 53. The first oil passing hole 531 communicates with the accommodation cavity 52. The annular groove 533 communicates with the oil feedback hole 13 and the oil passing gap 42 separately. Through the match among the first oil passing hole 531 in the axial direction, the second oil passing hole 532 in the radial direction of the valve core 30, and the annular groove 533 in the circumferential direction, the hydraulic oil can flow smoothly in the oil passage 53, reducing flow resistance and pressure loss.

In this embodiment, as shown in FIG. 5, the pressure compensation valve further includes a plug 70. The plug 70 is disposed inside the first valve core segment 31 of the valve core 30. The throttle hole 51 and the accommodation cavity 52 are each disposed inside the plug 70. As an independent component, the plug 70 can be precisely processed separately, guaranteeing the dimensional precision of the throttle hole 51 and the accommodation cavity 52. Moreover, the blocking member 60 can be placed in the accommodation cavity 52 more conveniently. In the case of a problem such as a blockage in the throttle hole 51 and the accommodation cavity 52 in use, only the plug 70 is to be replaced with no need for replacing the entire valve core 30. The plug 70 matches the valve core 30 to form the one-way throttle channel, reducing processing costs, assembly difficulty, and maintenance costs.

Optionally, as shown in FIG. 5, the first valve core segment 31 of the valve core 30 is provided with an accommodation groove. The plug 70 is accommodated in the accommodation groove and is in a threaded connection with the valve core 30. Through the threaded connection, the plug 70 can be tightly fixed in the accommodation groove and does not easily loosen or fall off. Moreover, the threaded connection facilitates maintenance and replacement. If the plug 70 or the valve core 30 is worn, or if the throttle hole 51 or accommodation cavity 52 in the plug 70 is blocked, the plug 70 can be easily unscrewed and replaced with a new plug 70 or a new valve core 30, thereby improving maintenance efficiency. It is to be noted that in other embodiments, the plug 70 may be fixed in the valve core 30 by snapping or through a locking member.

In some embodiments, the diameter of the first valve core segment 31 of the valve core 30 is smaller than the inner diameter of the first main body 15 of the valve sleeve 10. The oil passing gap 42 is formed between the outer wall of the first valve core segment 31 and the inner wall of the first main body 15. The diameter of the second valve core segment 32 of the valve core 30 is slightly smaller than the inner diameter of the second main body 16 so that the second valve core segment 32 is slidably guided within the second main body 16. In an embodiment, the difference between the inner diameter of the second main body 16 and the diameter of the second valve core segment 32 is kept within a tolerance allowable range of 0.01 mm to 0.02 mm. The oil passing gap 42 is formed through the difference of the dimension of the first valve core segment 31 and the dimension of the first main body 15, guaranteeing that the hydraulic oil flows into or out of the first cavity 41 through the oil passing gap 42. Through the small-gap match between the second valve core segment 32 and the second main body 16, it can guarantee that the valve core 30 slides only in the axial direction without shaking, reducing the collision or wear between the valve core 30 and the valve sleeve 10 and prolonging the service life of the pressure compensation valve.

In some embodiments, referring to FIG. 6, the diameter of the second valve core segment 32 of the valve core 30 is slightly smaller than the inner diameter of the second main body 16 so that the second valve core segment 32 is slidably guided within the second main body 16. The first valve core segment 31 of the valve core 30 is provided with an oil passing groove 311 in the axial direction of the valve core 30 to form the oil passing gap 42. Through the small-gap match between the second valve core segment 32 and the second main body 16, it can guarantee that the valve core 30 slides only in the axial direction, reducing collision or wear and prolonging service life. The arrangement in which the first valve core segment 31 is provided with the oil passing groove 311 to form the oil passing gap 42 guarantees that the hydraulic oil flows into or out of the first cavity 41 through the oil passing gap 42.

As shown in FIG. 5, the elastic structure 80 includes an elastic member 81 and a mounting member 82. One end of the elastic member 81 abuts against the second valve core segment 32 of the valve core 30. The other end of the elastic member 81 is disposed on the mounting member 82 and abuts against the mounting member 82. The mounting member 82 is fixed inside the valve sleeve 10 and is located on an end facing the oil inlet hole 11 of the valve sleeve 10. The elastic member 81 can guarantee that the valve core 30 moves to a corresponding position under different pressures, changing the area of blocking the oil return hole 12. The mounting member 82 provides a stable support effect for the elastic member 81, enabling the elastic member 81 to abut against the valve sleeve 10 through the mounting member 82.

In this embodiment, the elastic member 81 is a spring.

In an embodiment, a through hole penetrates the mounting member 82 so that the hydraulic oil can enter the valve sleeve 10 through the oil inlet hole 11. That is, the hydraulic oil flowing from the oil inlet hole 11 can enter the valve sleeve 10 through the through hole, guaranteeing that the hydraulic oil flows from the oil inlet hole 11 without obstruction.

As shown in FIG. 5, the second valve core segment 32 of the valve core 30 is provided with a receiving cavity 34. The elastic member 81 extends into the receiving cavity 34 and abuts against the bottom of the receiving cavity 34. The elastic member 81 is arranged by disposing the receiving cavity 34 inside the valve core 30, significantly reducing the outer dimension of the pressure compensation valve and making the entire structure more compact.

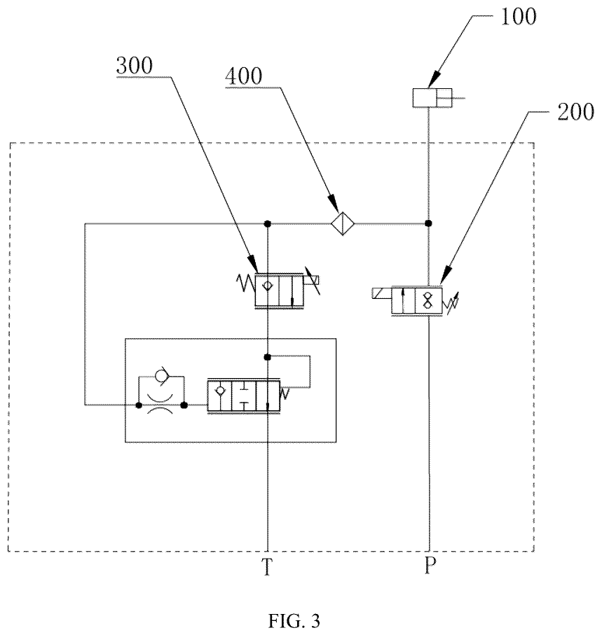

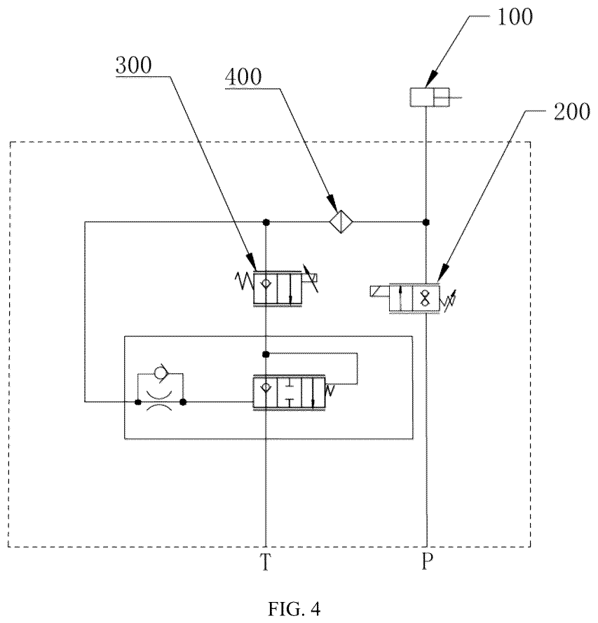

An embodiment, as shown in FIGS. 3 and 4, further provides a hydraulic control system. The system includes a lifting oil cylinder 100 and a lifting module controlling the lifting oil cylinder 100 to perform a lifting action. The lifting module includes an oil inlet and an oil outlet. A solenoid valve 200 is disposed between the oil inlet and an oil inlet end of the lifting oil cylinder 100. A proportional flow valve 300 and the preceding pressure compensation valve are sequentially disposed between the oil inlet end of the lifting oil cylinder 100 and the oil outlet. The oil inlet hole 11 of the pressure compensation valve communicates with the proportional flow valve 300. The oil return hole 12 communicates with the oil outlet. The oil feedback hole 13 communicates with the oil inlet end of the lifting oil cylinder 100.

As shown in FIG. 3, when a cargo needs to be lifted, the hydraulic oil in the oil inlet (Port P) reaches the lifting oil cylinder 100 through the solenoid valve 200, thereby completing a lifting action. When the cargo needs to be lowered, the proportional flow valve 300 is powered on and operates. The hydraulic oil in the lifting oil cylinder 100 returns to an oil tank through the oil outlet (Port T) through the proportional flow valve 300 and the pressure compensation valve, thereby completing a lowering action. In this process, the proportional flow valve 300 can control the current to control the lowering speed of the cargo. The pressure compensation valve can keep the pressure difference of the proportional flow valve 300 constant through the preceding structure so that the lowering speed is not affected by the load weight, thereby guaranteeing the stability of the lowering process.

As shown in FIG. 4, when the load needs to be kept unchanged at a certain height, the hydraulic oil in the lifting oil cylinder 100 is collectively cut off by the proportional flow valve 300, the pressure compensation valve, and the solenoid valve 200 that are in the closed state. The pressure compensation valve has the sealing portion 33 which can strictly form conical sealing with the connecting corner 14, thus avoiding the leakage of the hydraulic oil and thereby enabling the hydraulic system to have good stability when the load is held. Moreover, the pressure compensation valve has the one-way throttle channel, guaranteeing stability when the valve core 30 performs pressure compensation and generating a good use effect.

It is to be noted that in this embodiment, a filter screen 400 is also disposed between the solenoid valve 200 and the proportional flow valve 300. The filter screen 400 can effectively filter out fine impurities in the hydraulic oil, thereby preventing the fine impurities from blocking a small hole or a flow channel, preventing damage to another device during the circulation process, guaranteeing good hydraulic circulation, and prolonging the service life of the device.

What is claimed is:

1. A pressure compensation valve, comprising:
a valve sleeve, wherein an oil inlet hole, an oil return hole, and an oil feedback hole are disposed on the valve sleeve; an inner wall of the valve sleeve is provided with a connecting corner; and
the connecting corner is located between the oil return hole and the oil feedback hole;
a valve seat connected to the valve sleeve; and
a valve core slidably disposed inside the valve sleeve in an axial direction of the valve core to block or open the oil return hole, wherein the valve core has a first valve core segment and a second valve core segment, the first valve core segment and the valve seat enclose to form a first cavity, an oil passing gap is disposed between the first valve core segment and the valve seat, the oil passing gap communicates with the first cavity and the oil feedback hole, a sealing portion is disposed between the first valve core segment and the second valve core segment, and the sealing portion is configured to abut against the connecting corner to block a gap between the valve core and part of the valve sleeve between the oil return hole and the oil feedback hole.

2. The pressure compensation valve according to claim 1, wherein the valve sleeve comprises a first main body and a second main body connected to each other in an axial direction of the valve sleeve, an inner diameter of the first main body is greater than an inner diameter of the second main body, and the connecting corner is formed at a connection between the first main body and the second main body.

3. The pressure compensation valve according to claim 2, wherein a diameter of the first valve core segment is greater than a diameter of the second valve core segment, the first valve core segment is connected to the second valve core segment through a conical segment, an outer diameter of an end of the conical segment connected to the first valve core segment is greater than an outer diameter of an end of the conical segment connected to the second valve core segment, a circumferential surface of the conical segment forms the sealing portion, the first valve core segment is located inside the first main body, and the second valve core segment is slidably guided within the second main body.

4. The pressure compensation valve according to claim 3, wherein the oil passing gap is disposed as an annular cavity between the valve core and the valve seat in the axial direction of the valve core, and a size of the oil passing gap between the valve core and the valve seat on one side of the valve core is 0.2 mm to 0.5 mm.

5. The pressure compensation valve according to claim 3, further comprising an oil passing groove located in at least one of the valve seat or the valve core,
wherein in a case where the oil passing groove is located in the valve seat, a groove wall of the oil passing groove is recessed relative to an inner wall of the valve seat towards a side of the valve seat away from the valve core to form the oil passing gap;
in a case where the oil passing groove is located in the valve core, a wall of the oil passing groove is recessed relative to a surface of the valve core towards a side away from the valve seat to form the oil passing gap.

6. The pressure compensation valve according to claim 1, wherein the first valve core segment is provided with a one-way throttle channel communicating with the first cavity and the oil feedback hole, a blocking member is disposed inside the one-way throttle channel, and the blocking member is configured to control one-way flow of hydraulic oil from the first cavity to the one-way throttle channel.

7. The pressure compensation valve according to claim 6, wherein the one-way throttle channel comprises a throttle hole, an accommodation cavity, and an oil passage sequentially communicating with each other; another end of the throttle hole communicates with the first cavity; another end of the oil passage communicates with the oil feedback hole; the blocking member is disposed inside the accommodation cavity; and the blocking member is configured to make the throttle hole and the accommodation cavity disconnect from each other or communicate with each other.

8. The pressure compensation valve according to claim 7, wherein the oil passage comprises a first oil passing hole, a second oil passing hole, and an annular groove sequentially communicating with each other; the first oil passing hole is disposed in the axial direction of the valve core; the second oil passing hole is disposed in a radial direction of the valve core; the annular groove is disposed in a circumferential direction of the valve core; another end of the first oil passing hole communicates with the accommodation cavity; and the annular groove communicates with both the oil feedback hole and the oil passing gap.

9. The pressure compensation valve according to claim 8, further comprising a plug, wherein the plug is disposed inside the first valve core segment of the valve core, and the throttle hole and the accommodation cavity are each disposed inside the plug.

10. The pressure compensation valve according to claim 1, further comprising an elastic structure, wherein the elastic structure is disposed between the valve sleeve and the second valve core segment;
the valve sleeve comprises a first main body and a second main body;
a diameter of the first valve core segment of the valve core is smaller than a diameter of the second valve core segment of the valve core, the first valve core segment is located inside the first main body, and the second valve core segment is slidably guided within the second main body;
the oil passing gap is located between a circumferential side of the first valve core segment and the first main body of the valve sleeve; and
the first valve core segment is provided with a one-way throttle channel communicating with the first cavity and the oil feedback hole, a blocking member is disposed inside the one-way throttle channel, and the blocking member is configured to control one-way flow of hydraulic oil from the first cavity to the oil feedback hole.

11. The pressure compensation valve according to claim 10, wherein the one-way throttle channel comprises a throttle hole, an accommodation cavity, and an oil passage sequentially communicating with each other; the throttle hole communicates with the first cavity; the oil passage communicates with the oil feedback hole; the blocking member is disposed inside the accommodation cavity; and the blocking member is configured to make the throttle hole and the accommodation cavity disconnect from each other or communicate with each other.

12. The pressure compensation valve according to claim 11, wherein a first oil passing hole is disposed on the valve core in the axial direction of the valve core; a second oil passing hole is disposed on the valve core in a radial direction of the valve core; an annular groove is disposed on the valve core in a circumferential direction of the valve core; the first oil passing hole, the second oil passing hole, and the annular groove sequentially communicate with each other to form the oil passage; the first oil passing hole communicates with the accommodation cavity; and the annular groove communicates with the oil feedback hole and the oil passing gap.

13. The pressure compensation valve according to claim 12, further comprising a plug, wherein the plug is disposed inside the first valve core segment of the valve core, and the throttle hole and the accommodation cavity are each disposed inside the plug.

14. The pressure compensation valve according to claim 13, wherein the plug is detachably connected to the valve core.

15. The pressure compensation valve according to claim 14, wherein the plug is in a threaded connection with the valve core.

16. The pressure compensation valve according to claim 10, wherein the diameter of the first valve core segment of the valve core is smaller than an inner diameter of the first main body of the valve sleeve to form the oil passing gap, and the second valve core segment of the valve core is slidably guided within the second main body of the valve sleeve.

17. The pressure compensation valve according to claim 10, wherein the second valve core segment of the valve core is slidably guided within the second main body of the valve sleeve, and the first valve core segment of the valve core is provided with an oil passing groove in the axial direction of the valve core to form the oil passing gap.

18. The pressure compensation valve according to claim 10, wherein the elastic structure comprises an elastic member and a mounting member, one end of the elastic member is configured to abut against the second valve core segment of the valve core, another end of the elastic member is disposed on the mounting member and configured to abut against the mounting member, the mounting member is fixed inside the valve sleeve and is provided with a through hole for the hydraulic oil to flow through.

19. The pressure compensation valve according to claim 18, wherein the second valve core segment of the valve core is provided with a receiving cavity, and the elastic member extends into the receiving cavity and is configured to abut against a bottom of the receiving cavity.

20. A hydraulic control system, comprising:
a lifting oil cylinder and a lifting module configured to control the lifting oil cylinder to perform a lifting action, wherein the lifting module comprises an oil inlet and an oil outlet, and a solenoid valve is disposed between the oil inlet and an oil inlet end of the lifting oil cylinder;
wherein a proportional flow valve and the pressure compensation valve according to claim 1 are sequentially disposed between the oil inlet end of the lifting oil cylinder and the oil outlet, the oil inlet hole of the pressure compensation valve communicates with the proportional flow valve, the oil return hole communicates with the oil outlet, and the oil feedback hole communicates with the oil inlet end of the lifting oil cylinder.
